(19) United States
(12) Patent Application Publication
(10) Pub. No.: US 2021/0016594 A1
(43) Pub. Date: Jan. 21, 2021

(54) SYSTEM OF MEANS FOR INDEXING THE BOOKS OF THE BIBLE

(71) Applicant: Elena Alikovna VYSOCHINA, Odessa (UA)

(72) Inventor: Elena Alikovna VYSOCHINA, Odessa (UA)

(21) Appl. No.: 17/040,667

(22) PCT Filed: Aug. 29, 2018
(86) PCT No.: PCT/UA2018/000095

§ 371 Date: Sep. 23, 2020

(30) Foreign Application Priority Data
Mar. 23, 2018 (UA) U 2018 02961
Jun. 13, 2018 (RU) 2018121876

(51) Int. Cl. B42F 21/04

(52) U.S. Cl. CPC B42F 21/04; B42P 2221/04

(57) ABSTRACT

The present invention relates to an indexing system of the Bible. The system comprises a textual content identifier (1) as a list including plurality of sequences and a plurality of tab-rates (2) comprising the printed numbers on its front surface and a ply of self-adhesive material on its rear surface. Moreover, the textual content identifier (1) includes three sequences: the first sequence is a set of Old Testament book titles, which are located next to the chapter number in the Bible, respectively; the second sequence is a set of New Testament book titles, which are located next to the chapter number in the Bible respectively and is done in a different shade/color; the third sequence is arranged between the first and the second sequences; it includes numbers in numerical order. These features of this indexing system enables convenient and quick search, fast and precise selection of the specified pages in the Bible without turning pages. With long-term use of this indexing system, the memory of a user will retain the numbers from the tab-rates (2), so the search will be much quicker.

This utility model is connected to the printing industry, namely to a device for quick searching for specified chapters or pages in different books of the Bible.

In order to capture, keep and extract information from the Bible, there are indexes using one indexing system or another. The most popular indexing system is “Contents”.

With the appearance of wordbooks and encyclopedias, alphabetical indexes appeared as well. The advantage is in its simplicity: arranging and organizing its own indexing system of displaying information. With the help of that system, the scope of textual information is divided by the respective number of chapters according to the number of letters in the alphabet, with each chapter arranged in alphabetical order. Alphabetical order is usually learnt by heart and retained in the mind of a user. Thus, a user can turn to the contents, based on the alphabet.
Searching for and selection of a specified page include opening the book intuitively, then turning pages for the purpose of collating the word, which is being searched for. It is often accompanied by mistakes, re-searching, re-flipping pages. The user's mind is constantly busy with collating words and refocusing on addressing and finding the word meaning. This leads to the over-exhaustion and visual fatigue of a user, especially an elderly user.

Most of the quick-search page devices are the combinations of textual and non-textual tools. Some of the non-textual tools serve as information carriers, which are linked to book leaves.

The Bible is known to be a large, multi-page volume, which comprises the Old Testament and the New Testament, and Bible readers waste a lot of time while searching for a specified verse, chapter or book.

It resulted in the development of the advanced Bible indexing system which lets readers find the specified page more easily.

There is a model for a reference book (Patent of Ukraine #17551, prior. 27.05.96, published 06.05.97, IPC (2006) B 42, D 9/00, B 42, F 21/00). It has a tab attached to a fixture element. The tab can be rotated and has a low-level hardness area at the base.

A disadvantage of this device is a low informativeness, as a user has to flip pages, looking at the indexes displayed on the tabs and the number on a page. Moreover, if a user is an active Bible reader, the durability of the device decreases, due to a low-level hardness area at the base.

This is a device for page-searching in books (Patent of Ukraine, #61099, prior. 17.09.99, published 17 Nov. 2003, IPC 7 B 42 F 21/00, B 42 D 9/00). It has information carriers, which are linked to the pages of a book and visible when the book is closed. Textual content identifiers of pages or two pages opening start on the label of each textual identifier marked on the information carrier. This information carrier is linked to the leaf which corresponds to the text starting from a specified tag. The last tag of each textual identifier is displayed on the information carrier, which corresponds to the text, starting from this identifier.

However, when using such a device, the search procedure is decelerated, while search precision declines, especially in a multi-page volume such as the Bible.

The closest analogous solution to this utility model is an indexing system and a tool for book indexing (the U.S. Pat. No. 4,978,143, prior. 23.08.1989, published 18 Dec. 1990, IPC 5 B 42 F 21/100). It has a list of textual identifiers of contents, including an indexing table. This list comprises two word sequences: the first word sequence represents the title of the specified part of a book, in alphabetical order; the second word sequence represents the numbers arranged according to each word of the first word sequence respectively. It also has an information carrier list in the form of tab-rates. Each of them comprises the printed numbered marks, denoting one of the numbers.

The arrangement of book titles in the textual identifier in alphabetical order complicates the search, as each letter of the alphabet corresponds to several book titles. Moreover, using the second word sequence, which is not arranged in numerical order, results in a much more complicated search. Tab-rates consist of initial letters and the first syllables of book titles. It induces a user to flip pages in order to find the specified text.

The utility model's basic task is the development of the indexing system of the Bible by means of implementing a new textual content identifier and tab-rates, in order to provide a quick, convenient search and the appropriate selection of the specified page with the requested information.

This indexing system of Bible books has a list comprising the following sequences: a word sequence and a number sequence placed next to the word sequence respectively. This list also has a clearly stated amount of information carriers (tab-rates). Each of them has the printed numerical marks on its front face and a ply of self-adhesive material on its back face for fixation of tab-rates to respective pages, organized as a ladder row. According to the utility model concept, the textual content identifier includes three sequences: the first sequence is a set of Old Testament book titles, which are located next to the chapter number in the Bible, respectively; the second sequence is a set of New Testament book titles, which are located next to the chapter number in the Bible respectively and is done in a different shade/color; the third sequence is arranged between the first and the second sequences; it includes numbers in numerical order (from 1 to the predetermined maximum number). One number is simultaneously assigned to one of the Old Testament books and one of the New Testament books. Each tab-rate has space for displaying the respective number from 1 to 39 for the books of the Old Testament, and from 1 to 27 for the books of the New Testament, done in a different shade/color, distinctive from the color used for the Old Testament sequence.

The one accomplishment form represents the first, second and third sequences placed parallel to one another as columns.

The other accomplishment form represents the textual content identifier as a piece of paper with a sly of self-adhesive material placed on its bottom surface. This identifier is located on the front fly-leaf and/or the back fly-leaf of the Bible.

Another accomplishment form represents the list of the book titles of the New Testament and tab-rates used for marking the New Testament books in blue.

The other accomplishment form represents tab-rates consisting of two symmetrical parts. These parts have a tab attached to the fixation element. Both symmetrical parts' front surfaces of the tab comprise the respective numbers. The middle part of this index has a scored line. The fixation elements are made in the shape of a rectangle, with each tab-rate arranged only on the page on which the Bible book starts. Moreover, the tab-rates are arranged within the hard cover of the Bible and form the ladder row.

The other accomplishment form represents the double-faced sticker as the close texture piece of paper comprising the contents of the Bible on its front and back surfaces.

The suggested design of the textual content identifier enables convenient search, and quick and precise selection of the specified page in the Bible without turning pages, as the book titles of the Old Testament and the New Testament are arranged in integer numbers to the chapter number respectively. Each integer number corresponds to an Old Testament book and a New Testament book.

The use of the list located on the front fly-leaf and/or the back fly-leaf of the Bible as the textual content identifier enables quick and convenient selection, without putting in any effort while searching for and opening the specified page.

The use of integer numbers, ranging from 1 to 39 in the textual content identifier, enables the quick specification of the requested page, due to the limited sequence of numbers.

With long-term use of this device, the memory of a user will retain the numbers from the tab-rates, so the search will be much quicker, as the textual content identifier is no longer needed. This is not possible when using or reading regular Bible contents.

The use of the distinctive color (blue, in this case) for the books of the New Testament leads to the search acceleration of the requested book in this part of the Bible.

The use of the tab-rates, which are placed only on the pages, corresponds to the beginning of the specified book of the Bible and comprises two symmetrical parts displaying the numbers from 1 to 39 for the books of the Old Testament and from 1 to 27 for the books of the New Testament, leading to convenient searching, as well as retaining the initial depth of the book.

Besides, repeating the numbers of the tab-rates lets users search in both directions: from the start to the end and conversely, enabling the search with the help of page shifting, not regular page turning. This leads to the reduction of tab-rates' mechanical damage.

The use of the sticker enables searching while the Bible book is opened, when it is necessary to turn to the next Bible book without turning to fly-leaves, due to the contents arranged on the sticker.

This indexing system of the Bible may be implemented during the printing process, as well as when being used by the current user manually. In the latter case, the Bible can be marketed with the indexing tools: textual content identifier, a set of tab-rates and a sticker.

The suggested utility model is explained by the schematic drawing.

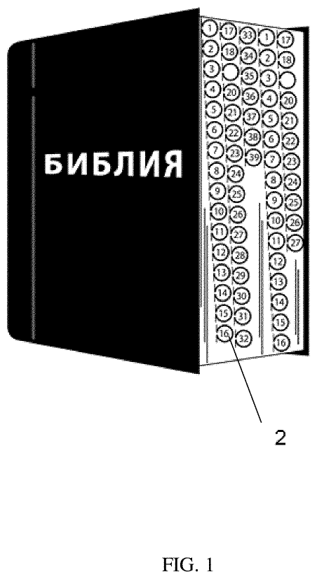

FIG. 1—the Bible and the implemented indexing system;

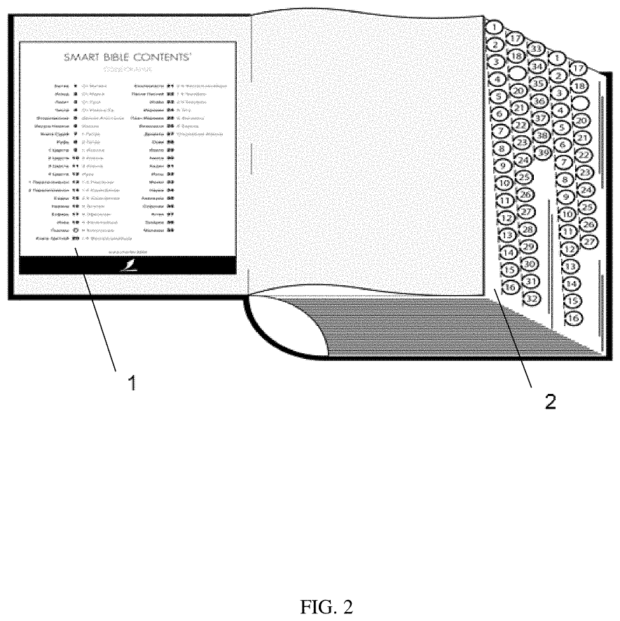

FIG. 2—the textual content identifier;

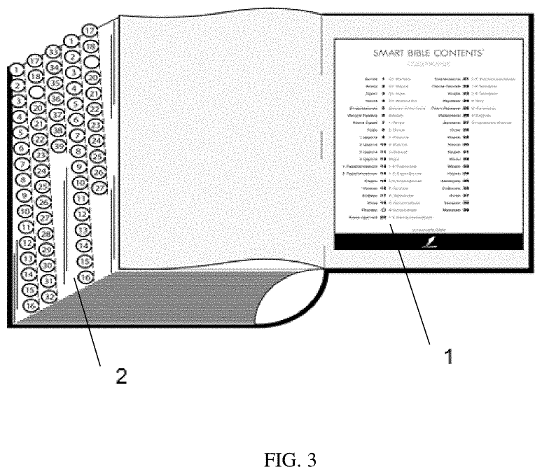

FIG. 3 the tab-rates for the denotation of the books of the Old Testament and the books of the New Testament;

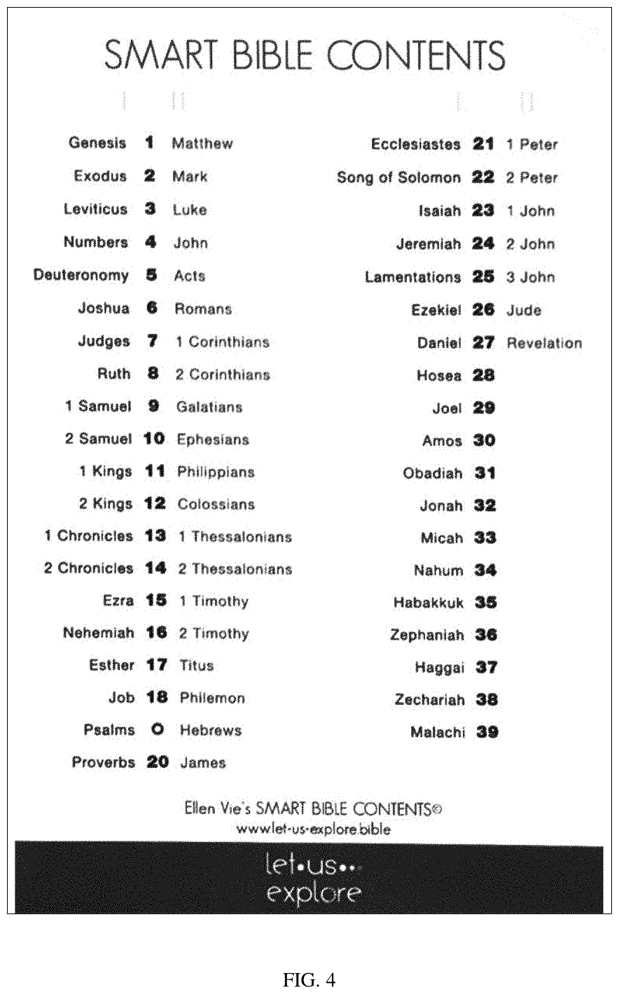

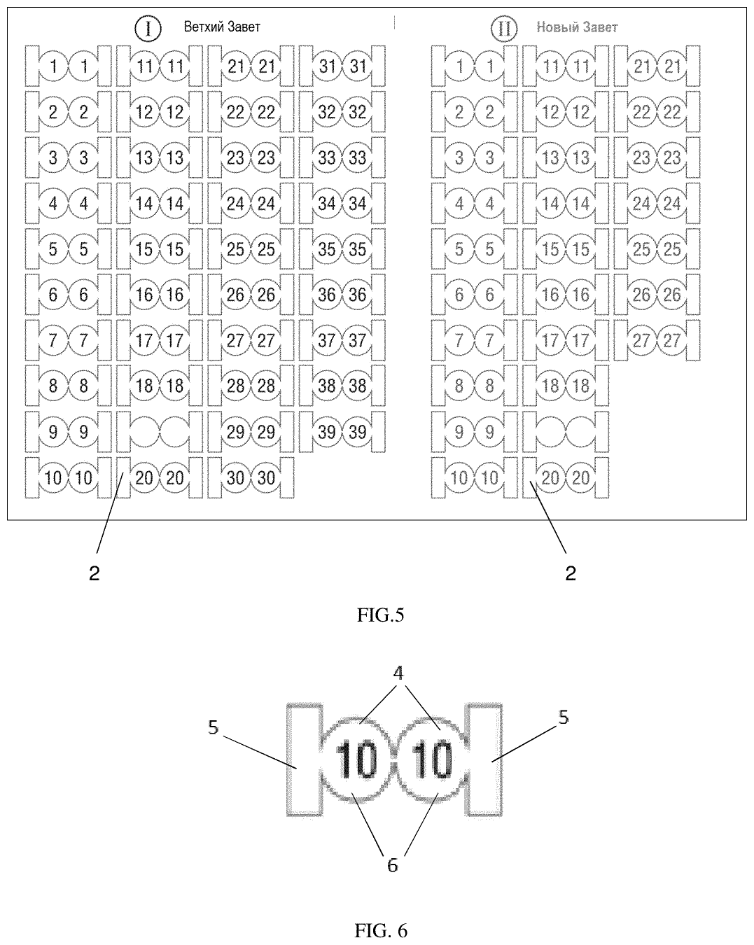

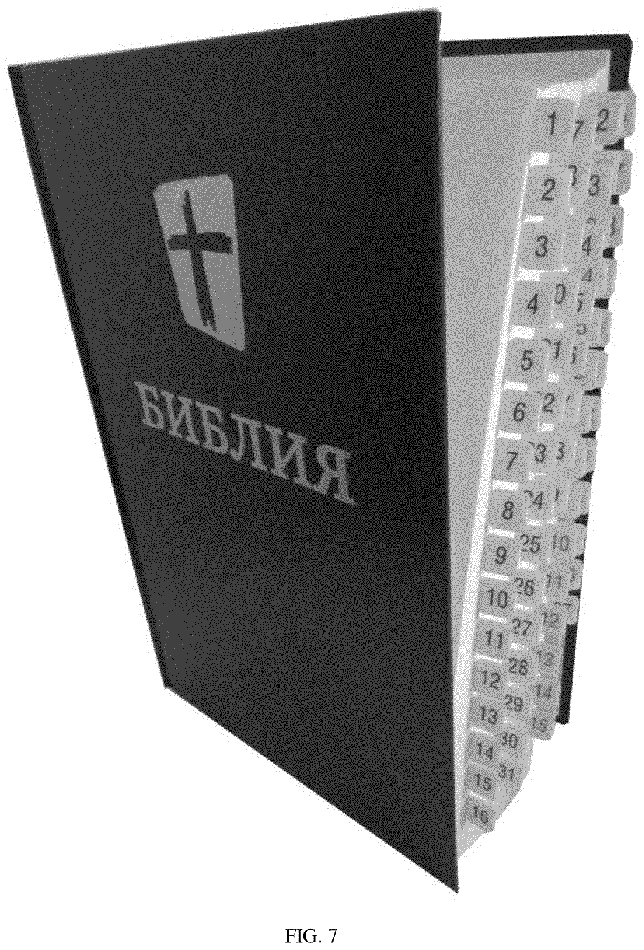

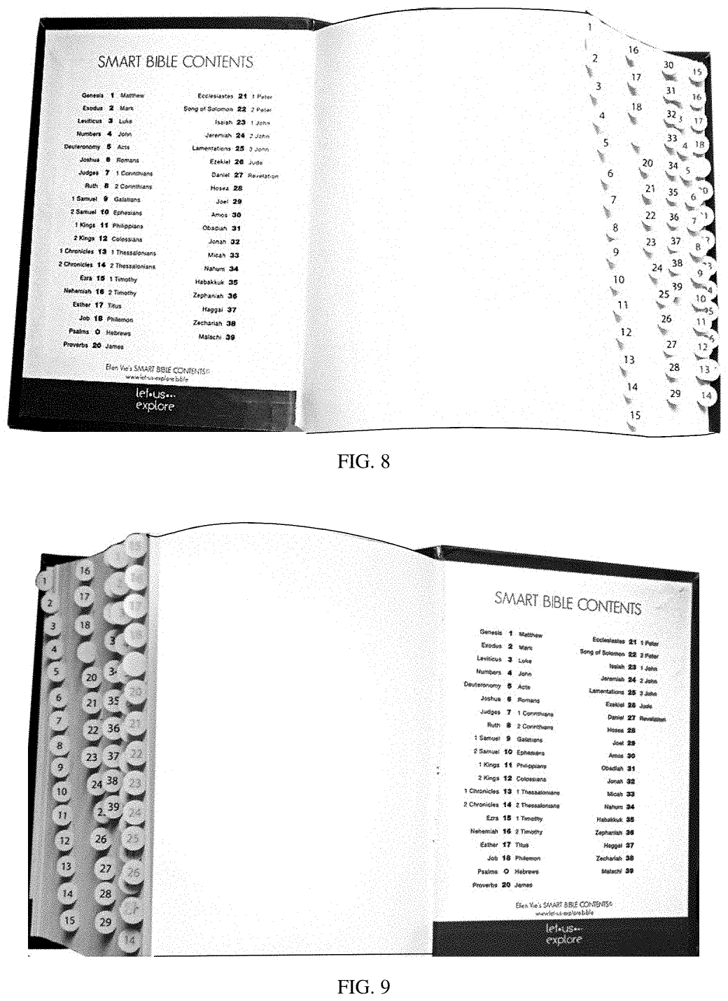

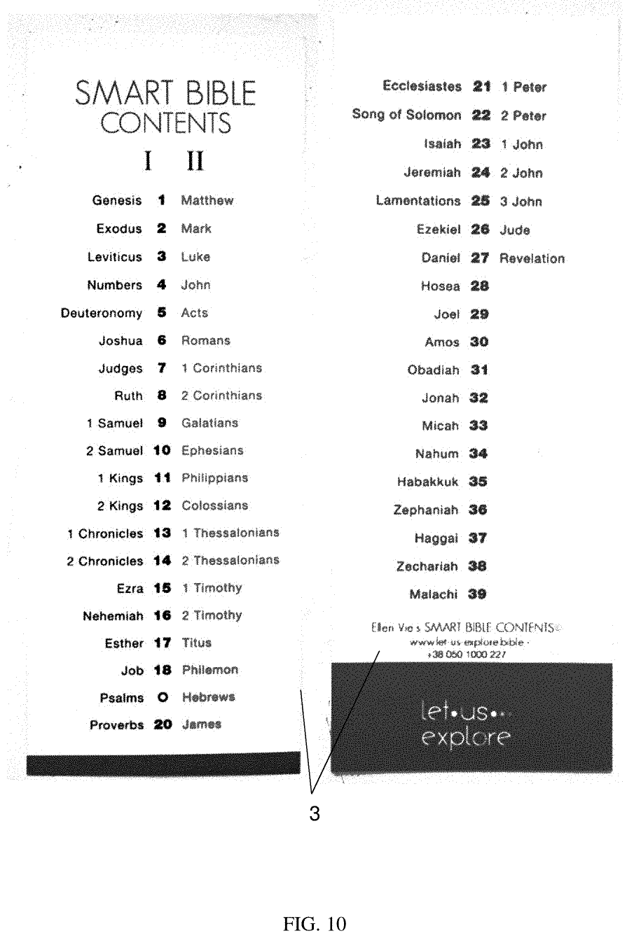

FIG. 4 the tab-rate design.

The indexing system comprises: the textual content identifier—1; tab-rates—2; a sticker—3. tab-rates (2) includes two symmetrical parts with a tab (4) attached to a fixation element (5) the front face surfaces of both symmetrical parts display the respective identical numbers (6).

The visual search for and manual selection of the specified Bible book include three steps:

1. Finding the specified book title in the textual content identifier.

Open one of the fly-leaves of the Bible; find the specified book title in the first or second sequences; identify the number from the third sequence, which corresponds with the book title in the Bible.

2. Choosing the specified tab-rate.

Find and touch the specified tab-rate with your fingers after the visual search.

3. Choosing the specified page.

Shift the page carefully to one side; raise the tab-rate with thumb and index finger; open the Bible on the page on which the specified book of the Old Testament or the New Testament starts.

Use the indexing system example.

As a task, you need to open Proverbs, the Old Testament book.

You open the front or back fly-leaf of the Bible and (1) find the book title “Proverbs” in the column of the first sequence of the textual content identifier (2) The book title corresponds to number 20 in the third sequence. You choose the respective black tab-rate (3) displaying the number 20. With one hand, you shift the pages laterally, holding the tab-rate with your other hand's fingers, and open the Bible. You examine the contents of the open pages, and identify the beginning of “Proverbs”. With a sticker (4), you mark this page in the Bible.

What is claimed is:

1. An indexing system of a Bible, comprising:
a textual content identifier (1) as a list including plurality of sequences comprising two word sequences and a sequence of numbers which are assigned to the words;
a plurality of tab-rates (2), comprising the printed numbers on its front surface and a ply of self-adhesive material on its rear surface;
wherein said tab-rates (2) as the means of carrying information and as means for fixation to the respective surface of the subject to be indexed, and further organized as the ladder row;
wherein said textual content identifier (1) includes a first sequence comprises the list of the Old Testament book titles, which are arranged by the respective chapter numbers in the Bible;
said textual content identifier (1) includes a second sequence comprises the list of the New Testament book titles, which are arranged by the respective chapter numbers in the Bible and are accomplished in a shade and/or color which is different from the color used for the Old Testament book titles; and
said textual content identifier (1) includes a third sequence arranged between the first and the second sequences and comprises the integer numbers located in a numerical order from one to the predetermined maximum number.

2.-5. (canceled)

6. The indexing system of the Bible of claim 1, wherein said indexing system further comprising a double-faced sticker (3) as a close texture piece of paper comprising the contents of the Bible on its front and back surfaces.

7. The indexing system of the Bible of claim 1, wherein said third sequence further comprising the integer numbers and each integer number corresponds to a book of the Old Testament and a book of the New Testament.

8. The indexing system of the Bible of claim 1, wherein said each tab-rate (2) further comprising the respective numbers from 1 to 39 for Old Testament books and from 1 to 27 for New Testament books.

9. The indexing system of the Bible of claim 3, wherein the list of each testaments book titles and tab-rates (2) are located with a different shade and/or color.

10. The indexing system of the Bible of claim 1, wherein the list of the New Testament book titles and the tab-rates (2) for the books of the New Testament are accomplished in a blue color.

11. The indexing system of the Bible of the preceding claims, wherein said tab-rates (2) consist of two symmetrical parts and these parts have a tab (4) attached to the fixation element (5).

12. The indexing system of the Bible of claim 6, wherein both symmetrical parts' front surfaces of the tab (4) comprises the respective numbers and the middle part of the index has a scored line.

13. The indexing system of the Bible of claim 6, wherein said fixation elements (5) are accomplished in the shape of a rectangle with each tab-rate arranging only on the page from which the Bible book starts.

14. The indexing system of the Bible of the preceding claims, wherein said tab-rates (2) are arranged within the hard cover of the Bible and form the ladder row.

15. The indexing system of the Bible of claim 1, wherein said first, second and third sequences are arranged parallel to one another as columns.

16. The indexing system of the Bible of claim 1, wherein said textual content identifier (1) is accomplished as a piece of paper with a ply of self-adhesive material placed on its rear surface, and is located on the front-fly-leaf and/or the back-fly-leaf of the Bible.
